(19) United States
(12) Patent Application Publication
(10) Pub. No.: US 2017/0326677 A1
(43) Pub. Date: Nov. 16, 2017

(54) METHOD AND APPARATUS FOR RESISTANCE WELDING OF STEEL SANDWICH SHEETS

(71) Applicants: ThyssenKrupp Steel Europe AG, Duisburg (DE); ThyssenKrupp AG, Essen (DE)

(72) Inventor: Chergui Azeddine, Dortmund (DE)

(73) Assignees: ThyssenKrupp Steel Europe AG, Duisburg (DE); ThyssenKrupp AG, Essen (DE)

(21) Appl. No.: 15/532,396

(22) PCT Filed: Oct. 30, 2015
(86) PCT No.: PCT/EP2015/075211

§ 371 Date: Jun. 1, 2017

(30) Foreign Application Priority Data
Dec. 4, 2014 (DE) 10 2014 117 923.4

(51) Int. Cl. B23K 11/11; B23K 11/00; B23K 11/34; B23K 103/16

(52) U.S. Cl. CPC B23K 11/115; B23K 11/34; B23K 11/002; B23K 2203/172

(57) ABSTRACT

A method for resistance welding a metallic component to a sandwich metal sheet with a thermoplastic layer disposed between two metallic cover layers may involve heating a region of the sandwich metal sheet to be welded such that the thermoplastic layer softens, displacing the thermoplastic layer from the region by compressing the cover layers, and welding the cover layers with the metallic component by means of a flow of electrical current in a first circuit via a first welding electrode disposed on a side of the sandwich metal sheet and a second welding electrode disposed on a side of the metallic component. The method for resistance welding has short cycle times, and a compact design and a process-reliable welded connection can be achieved. The method may further involve heating the region to be welded by a flow of current in a second circuit comprising the first welding electrode and an electrical conductor disposed between the first welding electrode and the sandwich metal sheet.”

The invention relates to a method for resistance welding a sandwich metal sheet to at least one further metallic component, wherein the sandwich metal sheet has two metallic cover layers and one thermoplastic layer arranged between the metallic cover layers, in which that region of the sandwich metal sheet which is to be welded is heated in such a way that the thermoplastic layer softens and is displaced from the welding region by compressing the cover layers, and the cover layers with the further component are welded to one another by means of a flow of electrical current in a first circuit via a first welding electrode arranged on the side of the sandwich metal sheet and a second welding electrode arranged on the side of the further metallic component. Furthermore, the invention relates to a device for resistance welding a sandwich metal sheet which has a thermoplastic layer arranged between metallic cover layers, having at least one further metallic component, having a first welding electrode which can be arranged on the side of the sandwich metal sheet and having a second welding electrode which can be arranged on the side of the further metallic component, having means for making available a first circuit, which means conduct the welding current at least via the first and second welding electrodes, and having means for displacing the plastic layer of the sandwich metal sheet from that region of the sandwich metal sheet which is to be welded.

The increasing demand for lightweight designs in the field of motor vehicles is placing increasing emphasis on the use of sandwich metal sheets which have a thermoplastic layer between two thin metallic cover layers, in order to further increase the potentials for saving weight in motor vehicle design by using sandwich metal sheets. Sandwich metal sheets can make available various properties which are frequently mutually exclusive and which provide new potentials for saving weight. For example, owing to the plastic layer, sandwich metal sheets have a significantly lower weight than solid metal sheets and at the same time make available high rigidity values. Furthermore, the sandwich metal sheets are sound-damping and provide a high level of rigidity. A disadvantage with sandwich metal sheets is, however, that they have an electrically insulating plastic layer which causes problems during fusion welding processes with regard to the formation of a satisfactory welded connection. Owing to the lack of suitability of the sandwich metal sheets for welding, for example for resistance welding or resistance spot welding to other metallic components, sandwich metal sheets are therefore frequently bonded or joined to one another mechanically.

German laid-open patent application DE 10 2011 109 708 A1 discloses a method for joining a sandwich metal sheet to a further metallic component, in which method the intermediate layer is fused on in the connecting region and displaced from the connecting region, with the result that subsequently a welded connection can be generated by establishing an electrical contact between the component and the cover layers of the sandwich metal sheet. It is proposed to heat the joint regions by means of electrodes or pressing elements whose temperature can be controlled. The welding electrodes or pressing elements are for this purpose provided, for example, with heating elements. The design of the welding electrodes is therefore relatively complicated. Furthermore, the speed of heating of the thermoplastic layer can be increased even further, with the result that shorter cycle times can be achieved.

Furthermore, U.S. Pat. No. 4,650,951 discloses a method for resistance welding two composite steel sheets, which method uses two welding electrodes which are heated and thereby heat and displace the plastic layer located between the cover layers, before the actual welding starts.

Furthermore, German patent application DE 10 2013 108 563, which was not published before the priority date of the present document, discloses a method in which two circuits are used to connect a sandwich metal sheet to a further metallic component by resistance welding. However, in this method a current bridge which is connected to the further metallic component is necessary to manufacture the second circuit. In addition, it has become apparent that the service life of the welding electrodes is in need of improvement.

Taking this as the basis, the object of the present invention is to make available a method for resistance welding of sandwich metal sheets and a corresponding device with which short cycle times, compact design and a process-reliable welded connection can be achieved.

The specified object is achieved according to a first teaching of the present invention with a method of the generic type by virtue of the fact that that region of the sandwich metal sheet which is to be welded is heated by a flow of current in a second circuit which comprises the first welding electrode and an electrical conductor arranged between the first welding electrode and the sandwich metal sheet.

It has become apparent that when a second circuit which comprises the first welding electrode and an electrical conductor arranged between the first welding electrode and the sandwich metal sheet is used, the welding region with a compact design can easily be heated. This is because, for example by virtue of a high electrical resistance, the electrical conductor can carry out the heating of the welding region without, for example, additional current bridges being necessary at the components to be welded. The heat is generated here by means of the contact resistance between the first welding electrode and the electrical conductor arranged between the first welding electrode and the sandwich metal sheet and/or by means of the electrical resistance of the electrical conductor arranged between the first welding electrode and the sandwich metal sheet itself. In this context, by providing the second circuit it is possible to achieve short cycle times, with the result that the method can be carried out economically. In addition, the wear and tear of the first welding electrode is reduced and its service life can be increased by means of the conductor arranged between the first welding electrode and the sandwich metal sheet. Finally, the electrical conductor can remain between the first welding electrode and the sandwich metal sheet even during the welding process itself and can influence said welding process in a positive way.

The electrical conductor arranged between the first welding electrode and the sandwich metal sheet can have, for example, a specific resistance which is higher than that of the welding electrodes, of the cover layers of the sandwich metal sheet and/or of the further metallic component.

According to a first refinement of the method according to the invention, a conductor ribbon is used as an electrical conductor arranged between the first welding electrode and the sandwich metal sheet. A conductor ribbon or contact-forming ribbon can, for example, be easily guided around the first welding electrode or encompass it so that the contact region of the welding electrode which would normally make contact with the sandwich metal sheet to be welded is covered by the conductor ribbon.

According to a further refinement of the method according to the invention, the conductor ribbon is arranged with a ribbon-guiding system between the first welding electrode and the sandwich metal sheet. By means of a ribbon-guiding system, the conductor ribbon can be provided in a particularly compact and reliable fashion between the first welding electrode and the sandwich metal sheet. In addition, the ribbon-guiding system can be embodied in such a way that the conductor ribbon can be moved with respect to the first welding electrode for the purpose of renewal. As a result, different locations of the conductor ribbon are positioned between the first welding electrode and the sandwich metal sheet, so that a change in the properties of the conductor ribbon in the region between the first welding electrode and the sandwich metal sheet can be counteracted. If the welding electrodes are made available, for example, by welding tongs, the ribbon-guiding system can be integrated, for example, into the welding tongs.

According to a further refinement of the method according to the invention, the electrical conductor which is arranged between the first welding electrode and the sandwich metal sheet makes contact directly with the first welding electrode and/or the sandwich metal sheet. The resistance in the first and second circuits and the heating can therefore be controlled well and a process-reliable method can be made available.

According to a further refinement of the method according to the invention, the flow of current for welding in the first circuit passes via the first welding electrode, the electrical conductor arranged between the first welding electrode and the sandwich metal sheet, the sandwich metal sheet, the further metallic component and the second welding electrode which is in contact with the further metallic component. The electrical conductor arranged between the first welding electrode and the sandwich metal sheet therefore does not need to be removed again during the welding. Instead, the electrical conductor can remain between the first welding electrode and the sandwich metal sheet. As a result, on the one hand, a simple method with particularly short cycle times can be made available. In addition, wear and tear on the first welding electrode is reduced by it being covered with the electrical conductor, with the result that long service lives can be achieved. Finally, the electrical conductor arranged between the first welding electrode and the sandwich metal sheet can be selected in such a way that it can also influence the welding process in a positive way, for example the formation of the welding nugget can be optimized.

According to a further refinement of the method according to the invention, the flow of current for heating in the second circuit passes via the first welding electrode, the electrical conductor arranged between the first welding electrode and the sandwich metal sheet, and a shunt conductor. The second circuit therefore does not comprise, in particular, the second welding electrode, the sandwich metal sheet and/or the further metallic component. For example, the flow of current for carrying out heating in the second circuit is provided with respect to the first welding electrode in the same way as the flow of current for welding in the first circuit is provided to the first welding electrode. For example, the electrical conductor arranged between the first welding electrode and the sandwich metal sheet is connected directly to the shunt conductor, for example a shunt current ribbon.

According to a further refinement of the method according to the invention, the first circuit is at least temporarily disconnected while the region of the sandwich metal sheet which is to be welded is heated by the flow of current in the second circuit. The first circuit is preferably permanently disconnected while that region of the sandwich metal sheet which is to be welded is heated by the flow of current in the second circuit. It is therefore possible to prevent undesired secondary currents. For example, it is possible to prevent the flow of current for carrying out heating in the second circuit from flowing via the first circuit, that is to say, in particular, via the second welding electrode. This is advantageous, for example, if multipoint welding is carried out.

According to a further refinement of the method according to the invention, the disconnection of the first circuit takes place by spacing apart the second welding electrode from the further metallic component or a separate switch. For example, a spacer element can be provided which permits the spacing apart. The spacer element can make contact here with the further component with an electrically insulated contact region. If a switch is provided, it can be embodied, for example, mechanically or electrically. For example, the switch can comprise a thyristor. The disconnection of the first circuit can thus be implemented in a particularly simple and process-reliable fashion. The disconnection can be controlled, for example, by means of a weld controller, for example as a function of a threshold value, for instance of a resistance threshold value. For example, the disconnection can be canceled if the electrical resistance between the first and the second welding electrodes drops.

According to a further refinement of the method according to the invention, the cover layers of the sandwich metal sheet are compressed by the first welding electrode and a spacer element arranged on the side of the further metallic component. For example, the spacer element simultaneously permits the second welding electrode to be spaced apart from the further metallic component for the disconnection of the first circuit. For example, the spacer element is spring-mounted. For example, the spacer element is part of welding tongs. In this context, the spring stiffness is, for example, sufficiently large to permit the cover layers to be compressed with the first welding electrode without contact between the second welding electrode and the further metallic component. For example, the spacer element enables contact between the second welding electrode and the further metallic component when a sufficiently large force is applied, for example also the welding force applied to the welding electrodes.

Alternatively, it is also possible for the cover layers of the sandwich metal sheet to be compressed by the first welding electrode and the second welding electrode.

According to a further refinement of the method according to the invention, the electrical conductor which is arranged between the first welding electrode and the sandwich metal sheet is adapted to the resistance welding to be carried out. For example, the material, the quality of the material, the thickness and/or the resistance of the electrical conductor can be adapted. Therefore, a suitable electrical conductor can be selected depending on the specific welding process. For example, the electrical conductor is selected in such a way that when welding is carried out the two metallic cover layers of the sandwich metal sheet are connected to the further metallic component. As a result of the fact that the first welding electrode makes contact with the sandwich metal sheet via the electrical conductor, but the second welding electrode does not, an asymmetrical embodiment of welding electrodes is effectively produced. For example, the electrical conductor which is arranged between the first welding electrode and the sandwich metal sheet can be selected in such a way that the embodiment of the welding nugget is optimized, for example is shifted in the direction of the sandwich metal sheet, with the result that a process-reliable connection of the metallic cover sheets of the sandwich metal sheet can take place.

According to a further refinement of the method according to the invention, electrical properties of the sandwich metal sheet are measured at least temporarily. It is therefore possible, for example, for a contact of the metallic cover layers of the sandwich metal sheet to be defined in the region which is to be welded. For example, the measurement is carried out during the heating of the welding region and the compression of the cover layers of the sandwich metal sheet. For example, a resistance-measuring process is carried out which includes the electrical resistance between the cover layers of the sandwich metal sheet. For example, the electrical resistance between the first and second welding electrodes is measured. If the cover layers have metallic contact, the resistance drops abruptly, with the result that metallic contact can be inferred.

According to a second teaching of the present invention, the indicated object is achieved by means of a device of the generic type by virtue of the fact that a second circuit is provided, wherein the second circuit comprises the first welding electrode and an electrical conductor which can be arranged between the first welding electrode and the sandwich metal sheet, with the result that that region of the sandwich metal sheet which is to be welded can be heated by a flow of current in the second circuit.

As already stated above, it is therefore easily possible to achieve heating of the welding region with a compact design. In this context, short cycle times can be achieved by means of the second circuit. In addition, if the electrical conductor is arranged between the first welding electrode and the sandwich metal sheet, this reduces the wear and tear on the first welding electrode and can increase the service life.

With respect to further advantageous refinements of the device, reference is made to the description of the embodiments of the method and the advantages thereof.

In this context, the description of method steps according to preferred embodiments of the method according to the invention is also intended to disclose corresponding means for carrying out the method steps by means of preferred embodiments of the device according to the invention. Likewise, the disclosure of means for carrying out a method step is intended to disclose the corresponding method step.

For example, in one refinement of the device according to the invention a ribbon-guiding system is provided with which the conductor ribbon can be arranged between the first welding electrode and the sandwich metal sheet.

In one refinement of the device according to the invention the electrical conductor which can be arranged between the first welding electrode and the sandwich metal sheet can preferably be arranged in such a way that the electrical conductor can make contact directly with the first welding electrode and/or the sandwich metal sheet.

In a further refinement of the device according to the invention, a disconnection mechanism is preferably provided for the first circuit. For example, the disconnection mechanism of the first circuit comprises a spacer element, which can be arranged on the side of the further metallic component, for spacing apart the second welding electrode from the further metallic component or a separate switch.

In a further refinement of the device according to the invention, the means for displacing the plastic layer of the sandwich metal sheet from that region of the sandwich metal sheet which is to be welded advantageously comprise the first welding electrode and a spacer element, with the result that the cover layers of the sandwich metal sheet are compressed by the first welding electrode and the spacer element.

In a further refinement of the device according to the invention, a measuring device for measuring electrical properties of the sandwich metal sheet is advantageously provided, for example for measuring the electrical resistance.

In the text which follows, the invention will be explained in more detail on the basis of exemplary embodiments in conjunction with the drawing, in which:

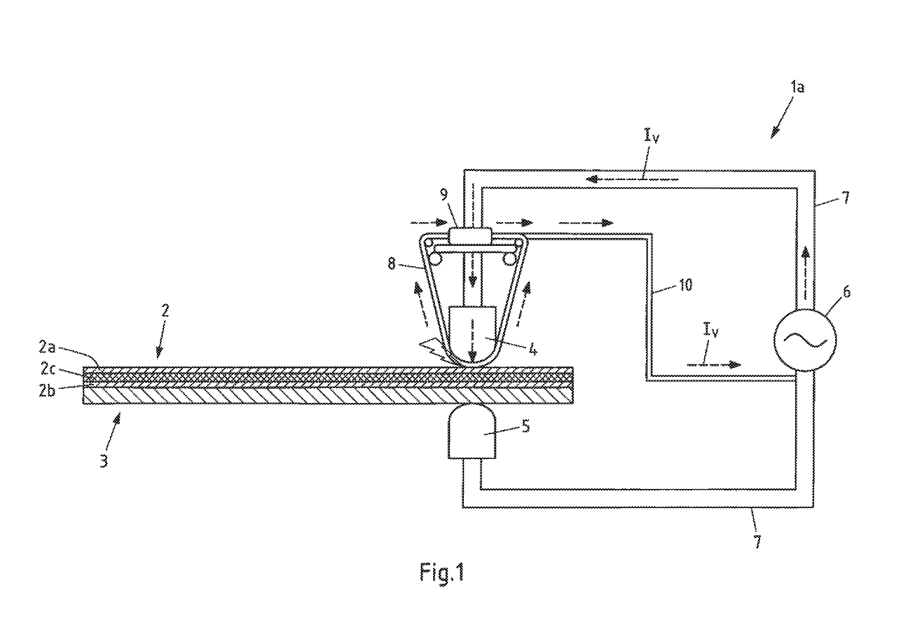

FIG. 1 shows a schematic illustration of an exemplary embodiment of a device and of a method during the flow of current for heating;

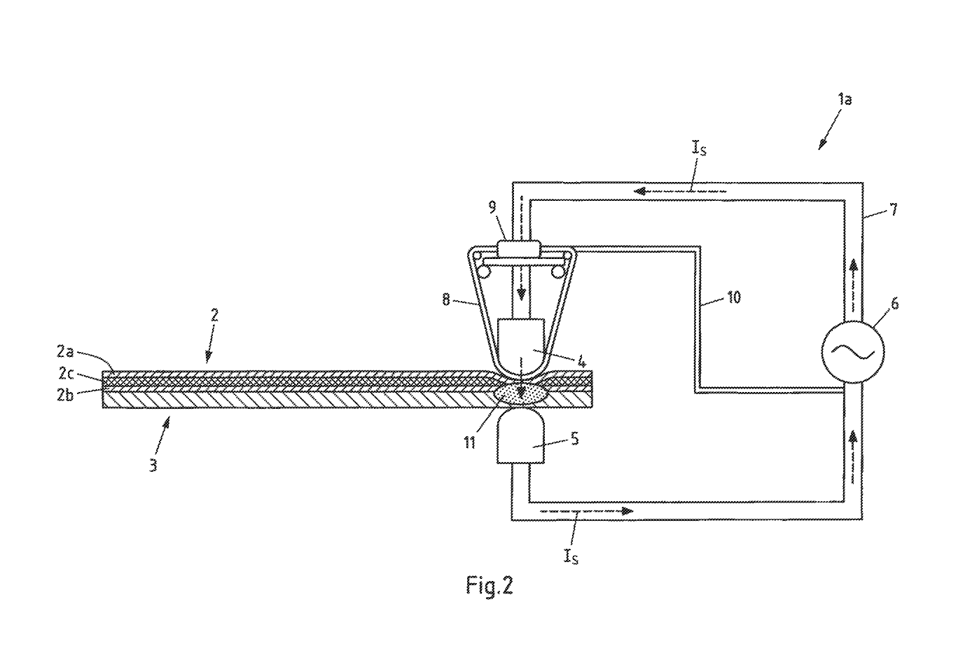

FIG. 2 shows a schematic illustration of the exemplary embodiment from FIG. 1 during the flow of current for welding;

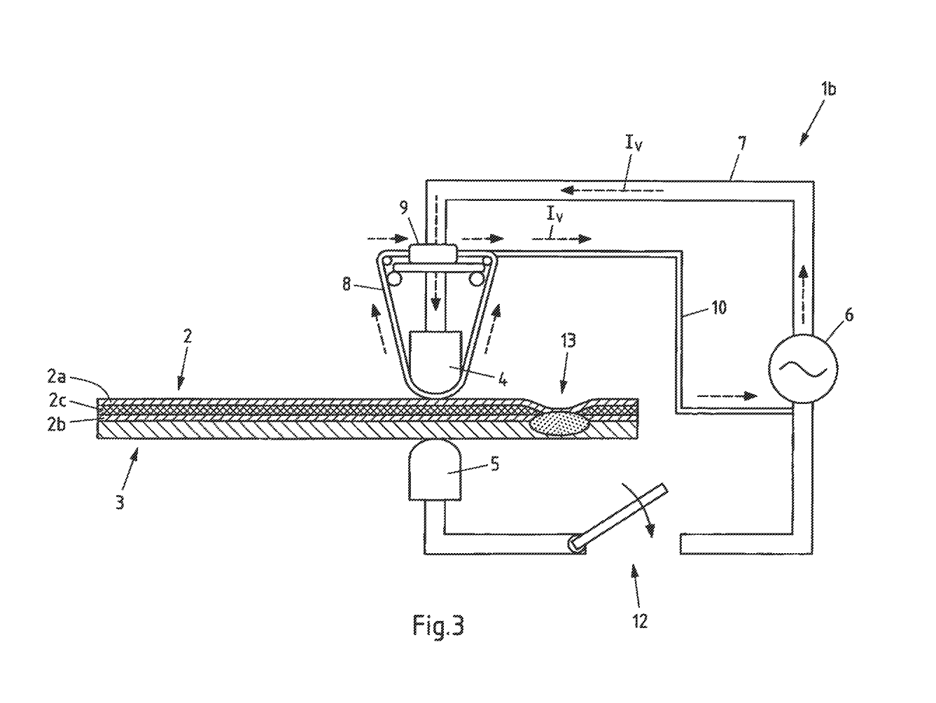

FIG. 3 shows a schematic illustration of a further exemplary embodiment of a device and of a method during the flow of current for heating;

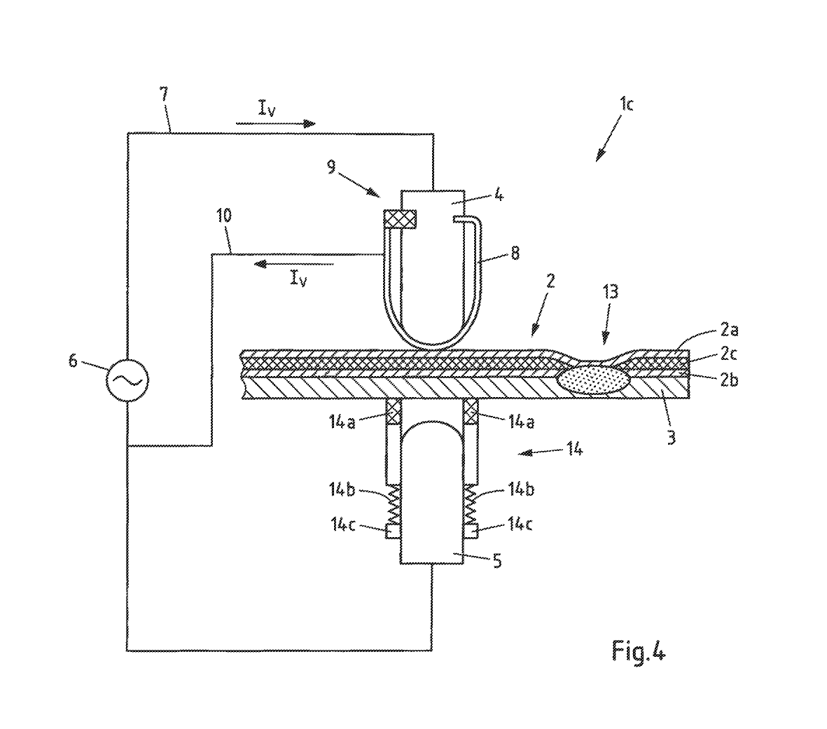

FIG. 4 shows a schematic illustration of a further exemplary embodiment of a device and of a method during the flow of current for heating;

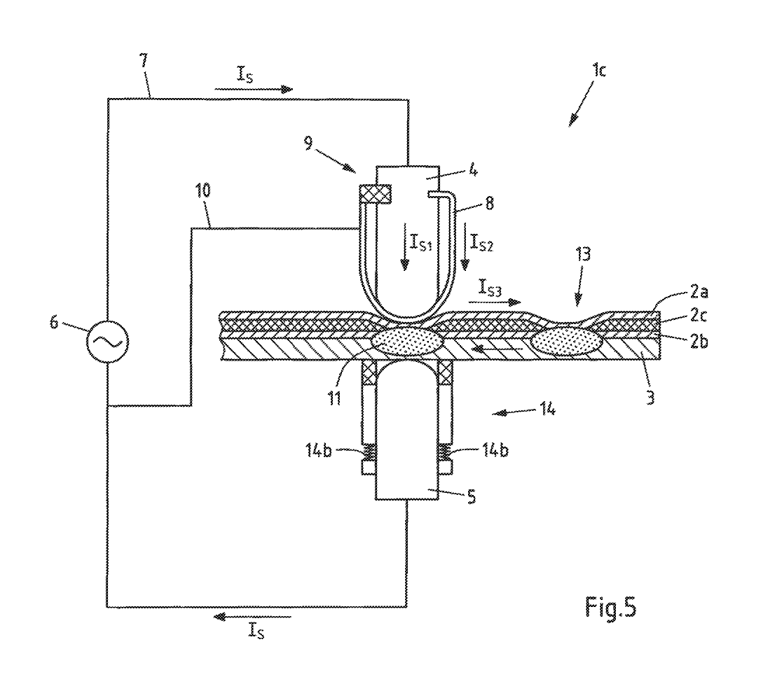

FIG. 5 shows a schematic illustration of the exemplary embodiment from FIG. 4 during the flow of current for welding,

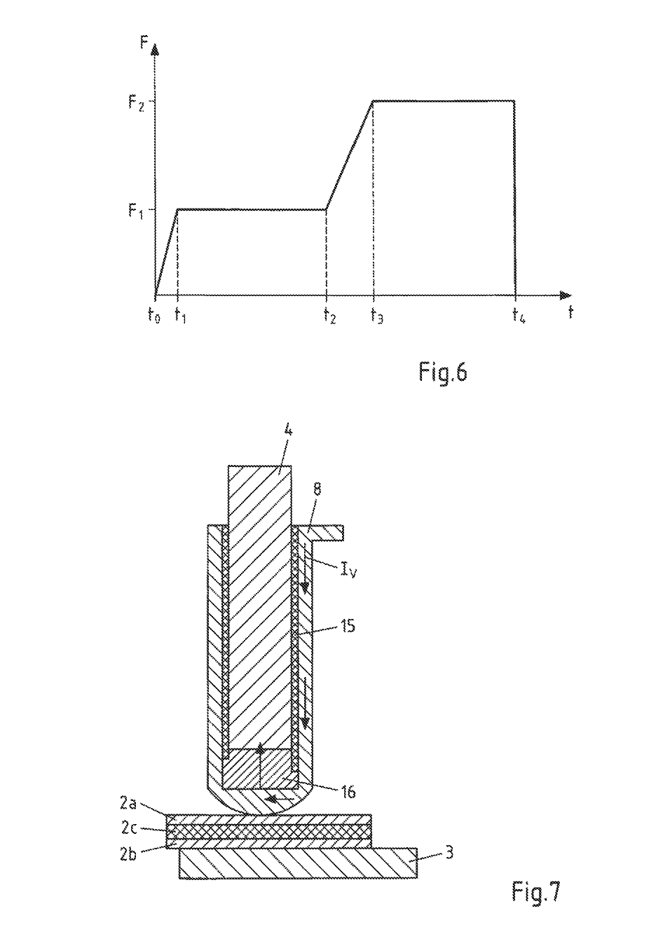

FIG. 6 shows a schematic illustration of the time profile of the force applied by the welding electrodes; and

FIG. 7 shows a further schematic illustration of an exemplary embodiment of a device.

FIG. 1 shows, in the first instance, a schematic illustration of an exemplary embodiment of a device 1a and a method during the flow of current for heating. With the device 1a, it is possible to perform resistance welding of a sandwich metal sheet 2 which has two metallic cover layers 2a, 2b and a thermoplastic layer 2c arranged between the metallic cover layers 2a, 2b, having a further metallic component 3, for example a solid metal sheet, for example a steel sheet. The device has a first welding electrode 4 and a second welding electrode 5. In this context, the first welding electrode 4 is arranged on the side of the sandwich metal sheet 2, and the second welding electrode 5 is arranged opposite on the side of the component 3. The device 1a makes available, with the power source 6 and the electrical wired 7, means for making available a first circuit. In addition, a force can be applied to the sandwich metal sheet 2 via the first welding electrode 4, with the result that the plastic layer 2c can be displaced. Means for applying force to the first and second welding electrodes 4, 5 are not illustrated in FIG. 1. This can be implemented, for example, by means of welding tongs.

In the device 1a, a second circuit is also provided which comprises the first welding electrode 4 and an electrical conductor 8 which can be arranged and is arranged between the first welding electrode 4 and the sandwich metal sheet 2. The electrical conductor 8 is embodied here as a conductor ribbon 8 which is arranged via a ribbon-guiding system 9 between the first welding electrode 4 and the sandwich metal sheet 2. In this context, the conductor ribbon 8 is in direct contact with the first welding electrode 4, on the one hand, and with the metallic cover layer 2a, on the other. The conductor ribbon 8 is additionally connected via a shunt conductor 10 to the power source 6. In this exemplary embodiment, the electrical wires 7 are insulated with respect to the conductor ribbon 8. A flow of current in the second circuit therefore passes via the electrical wires 7, the first welding electrode 4, the conductor ribbon 8 and the shunt conductor 10, with the result that the pre-heating current I_{V} flows in the second circuit. In particular, current can pass to the conductor ribbon 8 only via the first welding electrode 4. Heat for softening the plastic layer 2c is generated by means of the contact resistance between the first welding electrode 4 and the conductor ribbon 8 and the material resistance of the conductor ribbon 8.

At the same time, the cover layers 2a, 2b of the sandwich metal sheet 2 are compressed by the first and the second welding electrodes 4, 5, with the result that the first welding electrode 4 displaces the plastic layer 2c in the welding region. The result of the displacement of the plastic layer 2c is illustrated here in FIG. 2.

FIG. 2 then shows a schematic illustration of the exemplary embodiment from FIG. 1 during the flow of current for welding. The fact that the plastic layer 2c is now displaced from the welding region and the metallic cover layers 2a, 2b are in contact can be detected, for example, by virtue of the fact that the resistance between the cover layers 2a, 2b drops abruptly. In this case, the electrical resistance between the first and the second welding electrodes 4, 5 was measured by means of a weld controller (not illustrated). The welding current I_{S} can then be made available by means of the power source 6. In any case, the current in the first circuit flows via the electrical wires 7, the first welding electrode 4, the conductor ribbon 8, the metallic cover layers 2a, 2b, the further component 3, the second welding electrode 5 and in turn via the electrical wires 7. Further elements can also be provided in the circuit. In this context, a welding nugget 11 is formed which connects the metallic cover layers 2a, 2b of the sandwich metal sheet to the further metallic component 3. Since the conductor ribbon 8 is also arranged between the first welding electrode 4 and the cover layer 2a, it can also influence the actual welding process. An asymmetrical electrode design is effectively present for the first and second welding electrodes 4, 5, since the first welding electrode is, in contrast with the second welding electrode 5, in contact with the welded elements via the conductor ribbon 8. The production of the welding nugget 11 can be influenced by this. For example, the conductor ribbon 8 can be selected in such a way that in contrast to a symmetrical electrode design the welding nugget is shifted in the direction of the sandwich metal sheet. This can ensure that the metallic cover layer 2a is also connected. A flow of current via the shunt conductor 10 can be negligible given a correspondingly high resistance of the conductor ribbon 8. Alternatively, a switch, for example a shunt conductor 10, can also be provided for disconnecting the second circuit.

FIG. 3 shows a schematic illustration of a further exemplary embodiment of a device 1b and of a method during the flow of current for heating. The device 1b and the method which is carried out therewith correspond essentially to the device 1a and to the method carried out therewith. In this respect, reference is made initially to the description relating to FIGS. 1 and 2. In contrast to the device 1a, the device 1b has a switch 12 for disconnecting the electrical wire 7 between the second welding electrode 5 and the power source 6, with the result that the first circuit can be disconnected without disconnecting the second circuit. The switch 12 can be embodied for example in a mechanical or electrical fashion, for example as a thyristor circuit. The disconnection occurs during the heating of the welding point to the pre-heating current I_{V} by means of previous opening of the switch 12. This has the advantage that the method can be applied even in the case of multipoint resistance welding. If a spot weld connection 13 has already been produced, the pre-heating current IV would in any case not flow exclusively via the conductor ribbon 8 and the shunt conductor 10 but rather in any case also via the spot weld connection 13 which has already been formed, and via the second welding electrode 5. This is prevented by opening the switch 12, with the result that effective heating of the welding point is not adversely affected.

FIG. 4 shows a schematic illustration of a further exemplary embodiment of a device 1c and of a method during the flow of current for heating. The device 1c and the method carried out therewith is similar to the devices 1a, 1b and the methods carried out therewith. In this respect, reference is made in the first instance to the description relating to FIGS. 1, 2 and 3. In contrast to this, the ribbon-guiding system is implemented by virtue of the fact that the conductor ribbon 8 is conducted in an electrically conductive fashion to the first welding electrode 4 on the side lying opposite the shunt conductor 10. On the side lying opposite the shunt conductor 10, the conductor ribbon 8 is connected in an electrically insulated fashion to the welding electrode, and connected in an electrically conductive fashion to the shunt conductor 10. Undesired bypassing of the welding region to be heated by the pre-heating current I_{V} is prevented by the insulated connection.

As a further difference, the second welding electrode is connected to a spacer element 14 via the elements 14c. The spacer element 14 has an insulating region 14a with which the spacer element makes contact with the component 3. The second welding electrode 5 is arranged spaced apart from the further component 3. The first circuit is disconnected by the insulating region 14a and the spacing apart, with the result that during the heating with the pre-heating current I_{V} no undesired current flows via the welded connection 13 which has already been formed and via the spacer element 14 itself, such that a further separate switch 12 does not have to be provided.

Furthermore, the spacer element 14 also comprises spring elements 14b. The spring stiffness of the spring elements 14b of the spacer element 14 is configured here in such a way that during the heating with the pre-heating current I_{V} the second welding electrode 5 is spaced apart the further metallic component 3 from the component 3 despite the application of a force in the direction of the component 3. The application of force compresses the cover layers 2a, 2b of the sandwich metal sheet, as illustrated in FIG. 5.

FIG. 5 shows a schematic illustration of the exemplary embodiment from FIG. 4 during the flow of current I_{S} for welding in the first circuit. A welding force which is increased compared to the force application during the heating is then applied to the welding electrodes 4, 5. As a result, the spring elements 14b yield in such a way that the second welding electrode 5 can make contact with the further component 3. Therefore, the cover layers 2a, 2b can be welded, with the further component 3, to one another by means of the flow of the electrical welding current I_{S} in the first circuit via the first and second welding electrodes 4, 5 to form a welding nugget 11.

The conductor ribbon 8 divides the current I_{S} into the current I_{S1} through the first welding electrode and I_{S2} through the conductor ribbon 8. The current through the shunt conductor 10 can be ignored here. Therefore, both I_{S1} and I_{S2} contribute to the welding process. However, a partial current I_{S3} flows through the welded connection 13 which has already been formed and which therefore does not contribute to the welding process. I_{S3} is, however, very much smaller than I_{S1}+I_{S2}, and negligible. In addition, further secondary currents can be diverted through the sandwich metal sheet 2 or the component 3, which secondary currents can, however, also be ignored. The conductor ribbon can advantageously preferably be composed of three sections (not illustrated here) with different materials, which conductor ribbon is, for example, in the external sections/end sections composed of a material which is a good electrical conductor, for example a copper material, and the central region which is arranged, in particular, in the contact-forming region of the welding electrode 4 and the cover layer 2a, from another material, in particular with a high electrical resistance, for example from a steel material or from a tungsten material.

FIG. 6 shows a schematic illustration of the time profile of the force applied by the welding electrodes 4, 5 to the welded elements 2, 3. Firstly, the force applied to the welded elements 2, 3 is raised to a first value Fi up to the time t₁ and is held constant essentially up to t₂. In this context, the welding region is heated via the second circuit at least temporarily in the time period between t₁ and t₂. If the plastic layer is displaced from the welding region, the force is increased to a second value F₂ up to the time t₃ and is kept essentially constant up to the time t₄. Between t₃ and t₄ the welding is carried out by means of the welding current in the first circuit. Subsequently, the welded components 2, 3 or the welding electrodes 4, 5 can be removed or shifted.

FIG. 7 shows a schematic illustration of a part of a further exemplary embodiment of a device. The device comprises a first welding electrode 4 and an electrical conductor 8 which can be arranged and is arranged between the first welding electrode 4 and the sandwich metal sheet 2, which conductor 8 is embodied in the form of a welding electrode attachment and is fabricated, for example, from a copper material, wherein a partial region of the attachment 8 is electrically isolated from the welding electrode 4 by means of insulation 15. A material 16 which increases the electrical resistance, and which is fabricated, for example, from a steel material or tungsten material, is inserted underneath the insulation 15, as a junction region between the attachment 8 and the welding electrode 4.

1.-15. (canceled)

16. A method for resistance welding a sandwich metal sheet to a metallic component, wherein the sandwich metal sheet comprises a thermoplastic layer disposed between two metallic cover layers, the method comprising:
heating a region of the sandwich metal sheet to be welded in such a way that the thermoplastic layer softens;
displacing the softened thermoplastic layer from the region by compressing the two metallic cover layers; and
welding the metallic component to one or both of the two metallic cover layers by way of a flow of electrical current in a first circuit via a first welding electrode disposed on a side of the sandwich metal sheet and a second welding electrode disposed on a side of the metallic component,
wherein the region of the sandwich metal sheet to be welded is heated by a flow of electrical current in a second circuit that comprises the first welding electrode and an electrical conductor disposed between the first welding electrode and the sandwich metal sheet.

17. The method of claim 16 wherein a conductor ribbon is used as the electrical conductor disposed between the first welding electrode and the sandwich metal sheet.

18. The method of claim 17 further comprising disposing the conductor ribbon with a ribbon-guiding system between the first welding electrode and the sandwich metal sheet.

19. The method of claim 17 wherein the electrical conductor makes contact directly with at least one of the first welding electrode or the sandwich metal sheet.

20. The method of claim 16 wherein the flow of electrical current for welding in the first circuit passes via the first welding electrode, the electrical conductor disposed between the first welding electrode and the sandwich metal sheet, the sandwich metal sheet, the metallic component, and the second welding electrode that is in contact with the metallic component.

21. The method of claim 16 wherein the flow of electrical current for heating in the second circuit passes via the first welding electrode, the electrical conductor disposed between the first welding electrode and the sandwich metal sheet, and a shunt conductor.

22. The method of claim 16 further comprising at least temporarily disconnecting the first circuit as the region of the sandwich metal sheet to be welded is heated by the flow of electrical current in the second circuit.

23. The method of claim 22 wherein disconnecting the first circuit occurs by way of spacing apart the second welding electrode from the metallic component or a separate switch.

24. The method of claim 16 wherein the two metallic cover layers are compressed by the first welding electrode and a spacer element disposed on the side of the metallic component.

25. The method of claim 16 further comprising adapting the electrical conductor disposed between the first welding electrode and the sandwich metal sheet to the welding to be performed.

26. The method of claim 16 further comprising measuring electrical properties of the sandwich metal sheet.

27. A device for resistance welding a metallic component to a sandwich metal sheet having a thermoplastic layer disposed between metallic cover layers, the device comprising:
a first welding electrode configured to be disposed on a side of the sandwich metal sheet;
a second welding electrode configured to be disposed on a side of the metallic component;
means for making available a first circuit, wherein the means conduct a welding current at least via the first and second welding electrodes;
means for displacing the thermoplastic layer of the sandwich metal sheet from a region of the sandwich metal sheet to be welded;
a second circuit comprising the first welding electrode and an electrical conductor configured to be disposed between the first welding electrode and the sandwich metal sheet, wherein a flow of current in the second circuit is configured to heat the region of the sandwich metal sheet to be welded.

28. The device of claim 27 wherein the electrical conductor is a conductor ribbon.

29. The device of claim 28 further comprising a ribbon-guiding system with which the conductor ribbon can be disposed between the first welding electrode and the sandwich metal sheet.

30. The device of claim 27 wherein the electrical conductor is configured to be disposed between the first welding electrode and the sandwich metal sheet such that the electrical conductor is configured to make contact directly with at least one of the first welding electrode or the sandwich metal sheet.
